(19) United States
(12) Patent Application Publication
(10) Pub. No.: US 2016/0059495 A1
(43) Pub. Date: Mar. 3, 2016

(54) METHOD AND DEVICE FOR CONSTRUCTING A SHAPED BODY LAYER-BY-LAYER

(71) Applicant: IVOCLAR VIVADENT AG, Schaan (LI)

(72) Inventors: Jürgen Laubersheimer, Buchs (CH); David Schmid, Untervaz (CH)

(21) Appl. No.: 14/779,633

(22) PCT Filed: Mar. 24, 2014
(86) PCT No.: PCT/EP2014/055856

§ 371 Date: Sep. 24, 2015

(30) Foreign Application Priority Data
Mar. 28, 2013 (EP) 13161676.5

(51) Int. Cl. B29C 67/00

(52) U.S. Cl. CPC B29C 67/0096; B29C 67/0059; B29C 67/0088; B33Y 10/00

(57) ABSTRACT

The invention relates to a process for the layered construction of a shaped body by means of a 3D inkjet printing process with a piezo printhead (2) with several nozzles (6), to each of which a piezo element (8) is allocated which can act on the associated nozzle, in order to discharge ink from it. The piezo printhead (2) is moved, controlled by a control unit, over a construction area, the piezo elements are actuated individually for the locally selective application of filled ink, in order to apply a layer with a contour predetermined by the control unit. The applied layer is allowed to cure and the desired shaped body is constructed by successive application of layers, each with a predetermined contour. According to the invention, the control unit is set up to move the piezo printhead out of the construction area after a predetermined number of printed layers and/or if the control unit records a reduced discharge of ink in a nozzle (6) of the piezo printhead (2), then subject the nozzle or nozzles with reduced discharge or all the nozzles of the piezo printhead to a nozzle cleaning by stimulating the piezo element or elements (8) of the nozzles to be cleaned with a frequency of at least 20 kHz to generate ultrasound waves, in order to comminute and release any deposits in the nozzle.

The present invention relates to a method for the layered construction of a shaped body by means of a 3D inkjet printing process using a piezo printhead which has an ink feed system and several nozzles connected thereto, to each of which a piezo element is allocated which can act on the associated nozzle in order to discharge ink from it, wherein each piezo element of the piezo printhead can be actuated by a control unit individually to discharge ink, and its discharge is monitored by the control unit, wherein in the process the piezo printhead is moved, controlled by the control unit, over a construction area, the piezo elements are actuated by the control unit individually for the locally selective application of filled ink in order to thus apply a layer with a contour predetermined by the control unit, the applied layer is allowed to cure and, by successive application of layers with a predetermined contour in each case, the desired shaped body is constructed, as well as to a device suitable for this.

In particular, the invention is aimed at the production of ceramic shaped parts which are to be used as dental restorations. The “automated” production of dental prosthetics with CAD/CAM systems has been possible for some years. After making a digital impression (scanning in the mouth of the patient or on a moulded duplicate model), the dental prosthetic can be milled or ground from solid material with a milling machine on the basis of the scan data. However, these material-removal production processes have the disadvantage that most of the valuable ceramic materials used is lost. In addition, until now the machines used have been expensive and high-maintenance.

In addition to the material-removal processes, so-called “constructive processes” are also used, which are also known by the term “rapid prototyping” or “additive manufacturing”.

Examples of rapid prototyping processes are stereolithography and 3D inkjet printing processes, which are usually called inkjet printing. The principle of rapid prototyping is based on the layered construction of a three-dimensional shaped part. Two-dimensional layers with a predetermined contour in each case are built up one on top of the other.

Among 3D inkjet printing processes, the printing of polymerizable inks is only one of several processes. In addition, the printing of a binder into a powder bed and the printing of liquid waxes are also known. In 3D inkjet printing processes, following the same principle as conventional inkjet printers known in offices, 3D objects are printed directly by releasing polymerizable modelling materials (“inks”) in defined drops through a piezo printhead which can have several nozzles, curing the ink and thus forming a layer with the desired printed contour.

In inkjet printing, piezo printheads can be used which have an ink feed system and a plurality of nozzles connected to the ink feed system, wherein a piezo element is allocated to each nozzle. The piezo elements of the individual nozzles can be actuated separately by a control unit. The piezo elements are deformed in a targeted manner by applying control signals to the piezo elements, in order to discharge a discrete drop of ink through the nozzle with a defined drop size as a result of the deformation. The size and volume of the drops as well as the sequence of the drops from the nozzle can be controlled by the applied electrical pulses. The operating frequency of a piezo element as a rule ranges up to about 20 kHz, because of the geometry of the printhead and the rheology of the inks. The sum of the drops on a substrate yields the desired defined two-dimensional structure.

The nozzles of such a printhead typically have a very small opening, the size of which lies in the range of from 10 to 100 μm, as a result of which the discharged drops are consistently very small; their diameter corresponds, in a first approximation, to the opening of the nozzle, their volume lies in the picolitre range (10⁻¹⁰ to 10⁻¹² litres). It is therefore possible to print very fine structures in high resolution in such printing processes. In the case of 3D inkjet printing, highly fluid, polymerizable, usually photopolymerizable, substances which are cured immediately after the drops strike the substrate are usually used as inks for this. This typically happens by moving over a substrate one or more printheads which print a two-dimensional structure consisting of a large number of drops, ranged alongside one another, of a polymerizable ink provided with photoinitiators, and subsequently (or in parallel) carrying out an illumination with a light source which emits light with a suitable wavelength in order to polymerize the photopolymerizable material of the ink.

Inks for such 3D inkjet printing processes as a rule contain fillers. Fillers can be for example pigments, opacifiers, etc. which modify the optical properties of the ink. However, the flow properties of the ink can also be influenced or the rheology controlled by fillers. In the case of 3D inkjet printing for the construction of ceramic shaped bodies, filler particles are necessary. In this case, the filler particles are the actual construction material (e.g. oxide ceramic). The liquid surrounding them is merely the matrix for constructing these particles, using the described technique, to form a shaped body, wherein once the printing process is complete, the matrix is burnt off, to obtain ceramic shaped bodies, and the shaped body is then sintered. The particles do not influence the aspect ratios (thicknesses or layer heights) directly, but the mechanical, optical, thermal and electrical properties of the shaped body.

If it is desired to produce 3D shaped bodies from a particular material, such as for example metal or ceramic, filler particles are not just excipients for setting particular dimensions or mechanical properties of the shaped body, but an essential constituent of the ink, and the liquid constituents of the ink act as a kind of support substance. As a first approximation, the higher the proportion of solid in the suspension is, i.e. the more particles are contained in the ink as fillers, the more achievable the dimensions and mechanical properties of the three-dimensional shaped body are. Typically, the particle sizes lie in the range of from 0.1 to 1 μm, which are suitable in particular to achieve a high fill level. However, a high proportion of solid particles can have a negative effect on the ink, or subsequently on the discharge of drops/printing process, in two ways. For one thing, the viscosity of the ink increases with increasing fill level and thus the flow properties of the ink deteriorate. For another, there is the danger that the fine nozzles become blocked or partially clogged, whereby the discharge of drops can be prevented or impeded.

Ceramic-filled inks, so-called “slips”, which are suitable for the construction of dental restorations and which can be used in connection with the present invention in 3D inkjet printing processes are described in EP 2 233 449 A1. These inks can contain ceramic particles, wax and at least one radical polymerizable monomer. For further details of these materials, reference is made to the named published patent application. The preamble of claim 1 is based on the named document EP 2 233 449.

The object of the present invention is to improve a 3D inkjet printing process for the construction of shaped bodies and a device used for this such that the process and the device can also be used securely and without disruption when filled inks are used.

The process with the features of claim 1 and the device with the features of claim 6 serve to achieve this object. Advantageous embodiments of the invention are given in the dependent claims.

According to the invention, it is provided that, after printing a predeterminable number of layers or if a monitoring of the nozzles of the piezo printhead shows that one or more nozzles are displaying a disrupted discharge, the piezo printhead is moved out of the construction area. All the nozzles or the nozzle or nozzles in which a disrupted discharge has been established are then subjected to a nozzle cleaning, in that for every nozzle to be cleaned the associated piezo element is actuated by a control signal with a frequency of at least 20 kHz to produce ultrasound waves in order to comminute and release deposits or blockages therein using the ultrasound waves directed by the piezo element onto the nozzle.

The principle of operation of such a cleaning is based on cavitation. By cavitation is meant the formation and disintegration of vapour bubbles in liquids by pressure fluctuations. The ultrasonic field present in the liquid generates waves with positive and negative pressure. If such a negative pressure wave encounters an object to be cleaned, cavities filled with vapour form on small air bubbles acting as nuclei. When the subsequent high-pressure wave encounters the cavity, the static pressure in the cavity increases above saturation vapour pressure again due to the compression of said cavity. The vapour bubbles thereby condense abruptly at the speed of sound. Very high pressure peaks form. These cyclically forming and disappearing cavities can comminute and release deposits in the nozzle. In addition, the piezo elements are arranged in the immediate vicinity of the associated nozzles, with the result that they can very effectively direct ultrasonic energy onto the nozzles.

Without additional expenditure in terms of equipment, since the piezo elements used for nozzle cleaning are in fact necessary in any event for the actual inkjet printing process, it can be ensured, through the procedure according to the invention, that once the inkjet printing process has been interrupted the nozzles can be cleaned in the described way regularly or as soon as signs of blockages appear in order to remove deposits from them, after which the inkjet printing process for the construction of the shaped body is continued. The efficient functioning of the piezo printhead can thereby be ensured over the course of the inkjet printing process for the construction of the shaped body, without unchecked breakdowns of parts of the piezo printhead occurring because of blockages. Longer interruptions due to breakdown or partial malfunction of the piezo printhead can thereby be prevented. Furthermore, the production of defective shaped bodies, which can form when printing is carried out for too long with a partially malfunctioning piezo printhead due to blocked nozzles, can be prevented.

To carry out the cleaning function, the piezo elements can be operated with high-amplitude voltage pulses and with steep pulse edges (rise and fall times) to increase the transmitted mechanical energy. The periodic control pulses with a pulse repetition frequency of at least 20 kHz preferably have short rise times in the range of from 1 to 4 μs. The fall times preferably also lie in the range of from 1 to 4 μs. The amplitude of the control pulses for the ultrasound generation should be as high as possible, preferably at least 80% of the maximum amplitude allowable for the piezo elements.

In the procedure according to the invention, the inkjet printing process is briefly interrupted at regular intervals or when the first signs of blockages of one or more nozzles appear, the piezo printhead is moved to a location away from the construction area and the nozzle cleaning of affected nozzles is carried out there by generation of ultrasound waves by the associated piezo elements, after which the piezo printhead can be moved back into the construction area and the only briefly interrupted printing process can be continued.

In a preferred embodiment, it is provided that during the nozzle cleaning, in addition to the application of ultrasound, alternating hydrostatic positive and negative pressure is generated via the nozzle or nozzles, in order to wash away released deposits out of the nozzle or nozzles of the piezo printhead. This application of pressure can take place for example via a pump which introduces compressed air into an ink chamber, from which the ink feed system of the piezo printhead exits. The pressure set in the ink chamber therefore also determines the pressure of the ink in the nozzles compared with the ambient pressure.

The invention is described below with reference to an embodiment example in the drawings, in which:

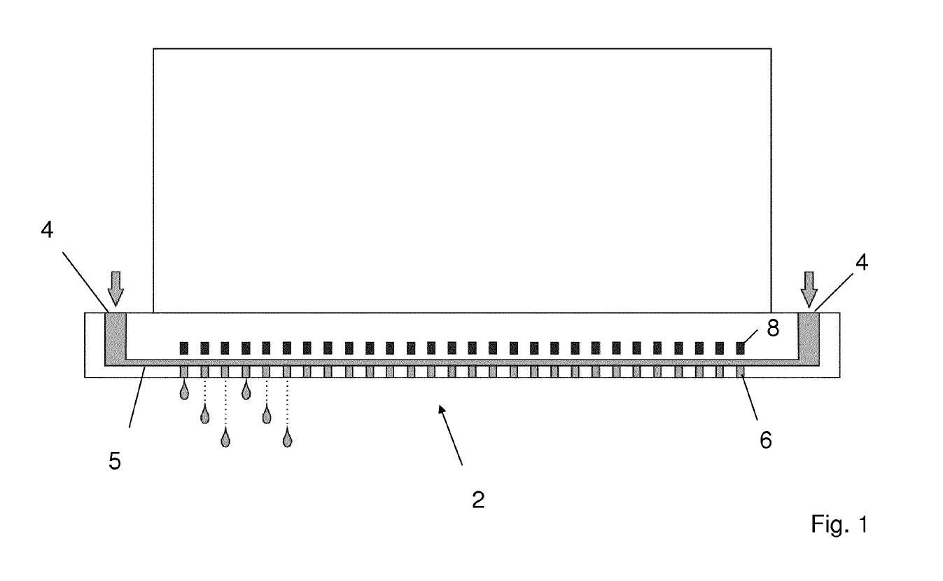

FIG. 1 schematically shows a front view of a piezo printhead in cross-section,

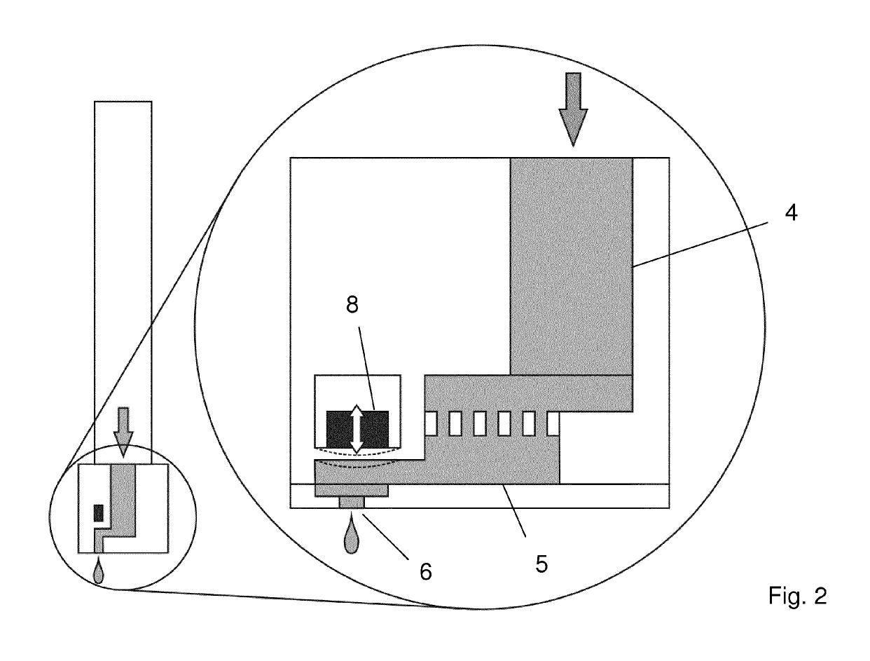

FIG. 2 shows a side view of the piezo printhead with a detail magnification,

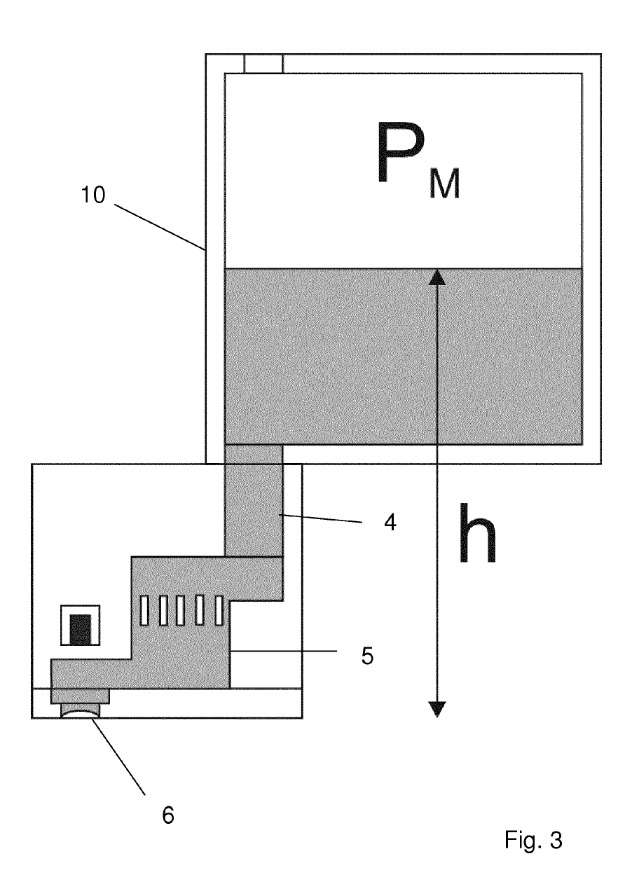

FIG. 3 shows a schematic lateral sectional view of the piezo printhead with an associated ink chamber,

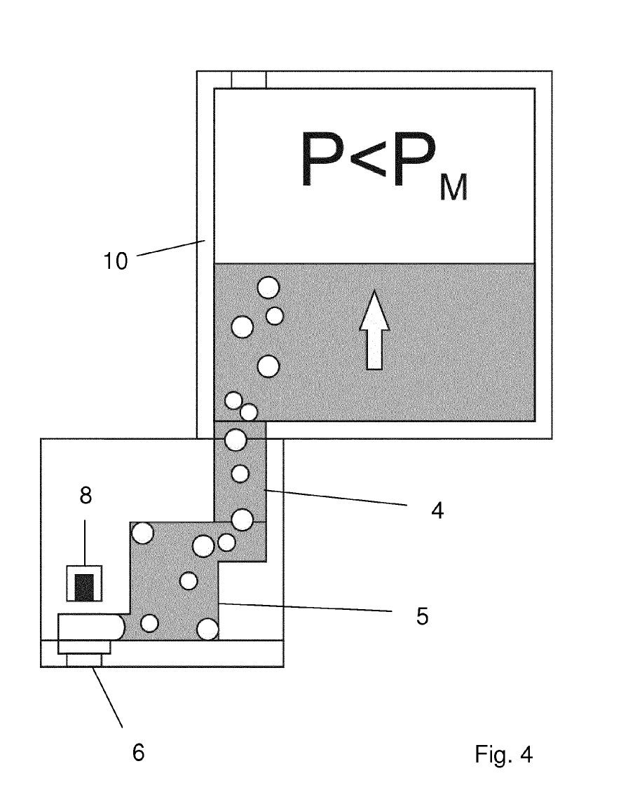

FIG. 4 shows a lateral sectional view like FIG. 3, with a negative pressure applied in the ink chamber,

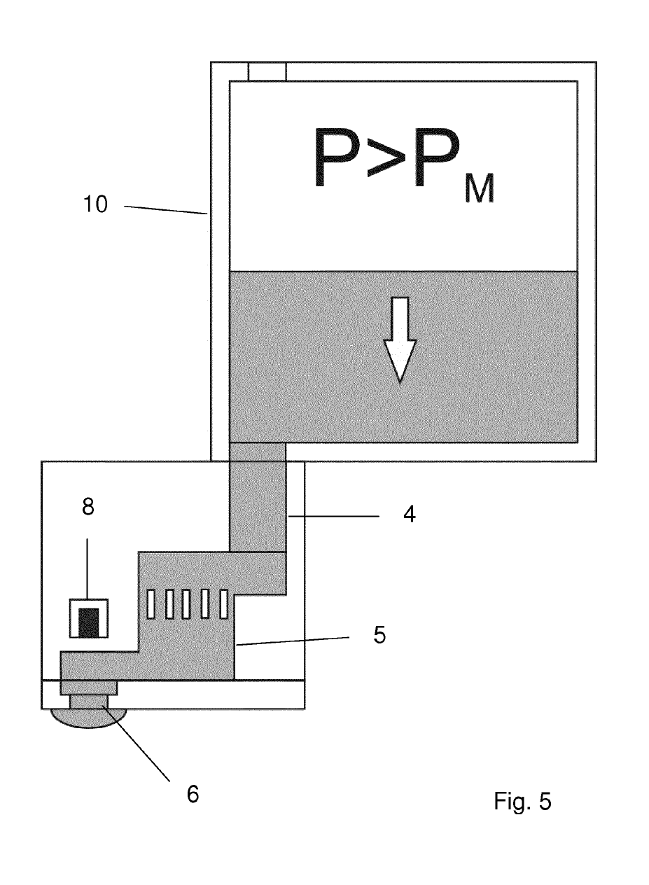

FIG. 5 shows a lateral sectional view like in FIG. 3, with a positive pressure applied in the ink chamber,

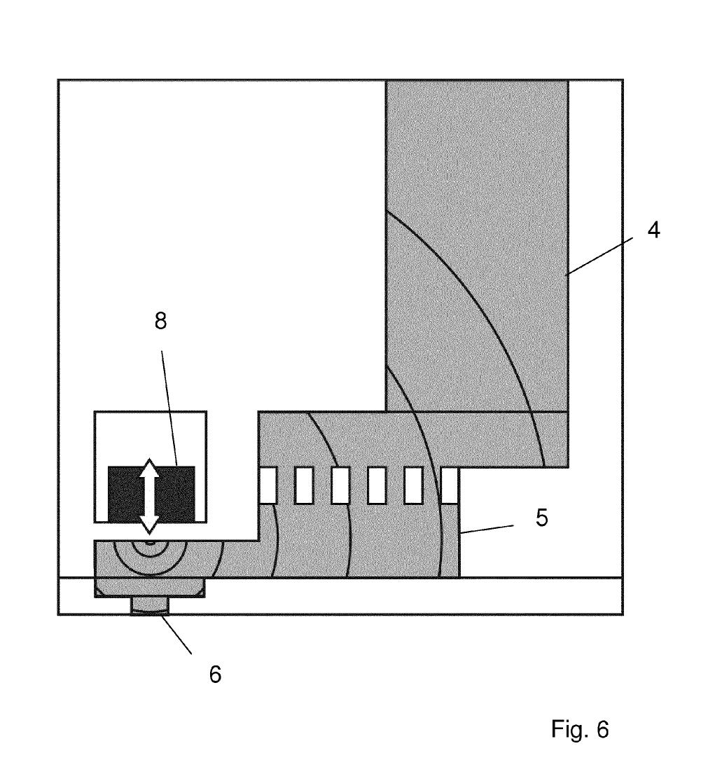

FIG. 6 shows a lateral sectional view of a section of the piezo printhead during generation of ultrasound waves by a piezo element,

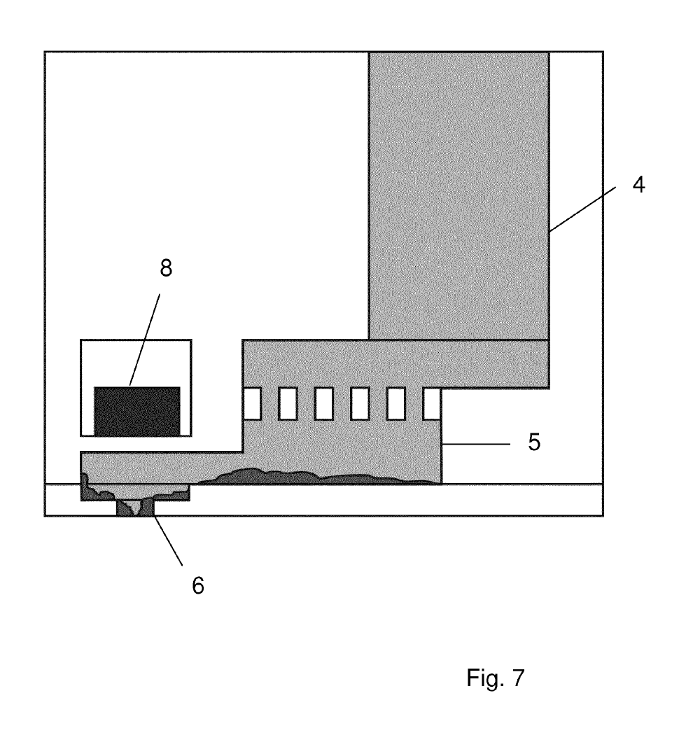

FIG. 7 shows a lateral sectional view of a section of the piezo printhead in which the formation of deposits in the nozzle and upstream thereof is shown,

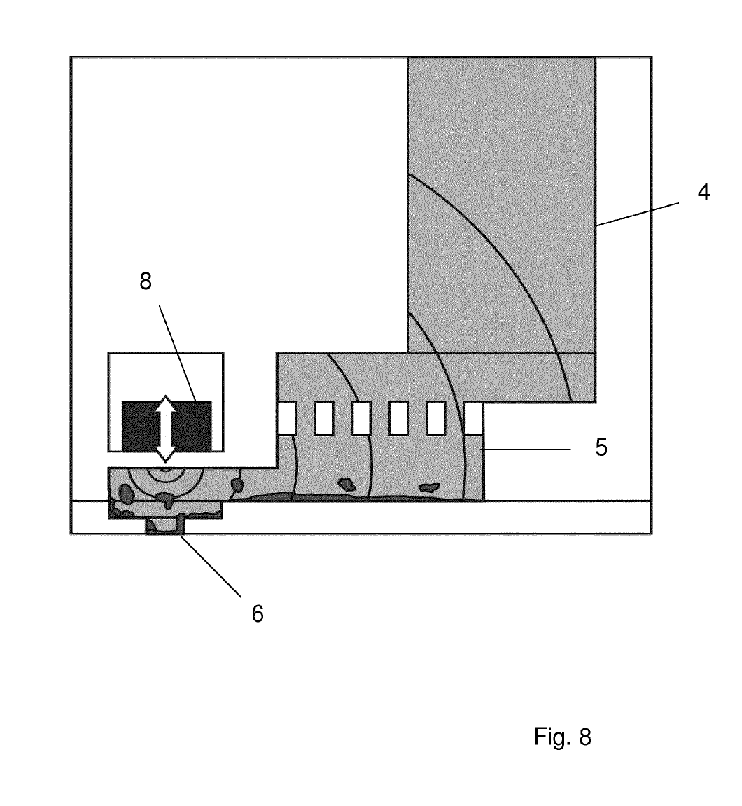

FIG. 8 shows a lateral sectional view like FIG. 7, wherein the piezo element of the nozzle represented is generating ultrasound waves in order to release the deposits,

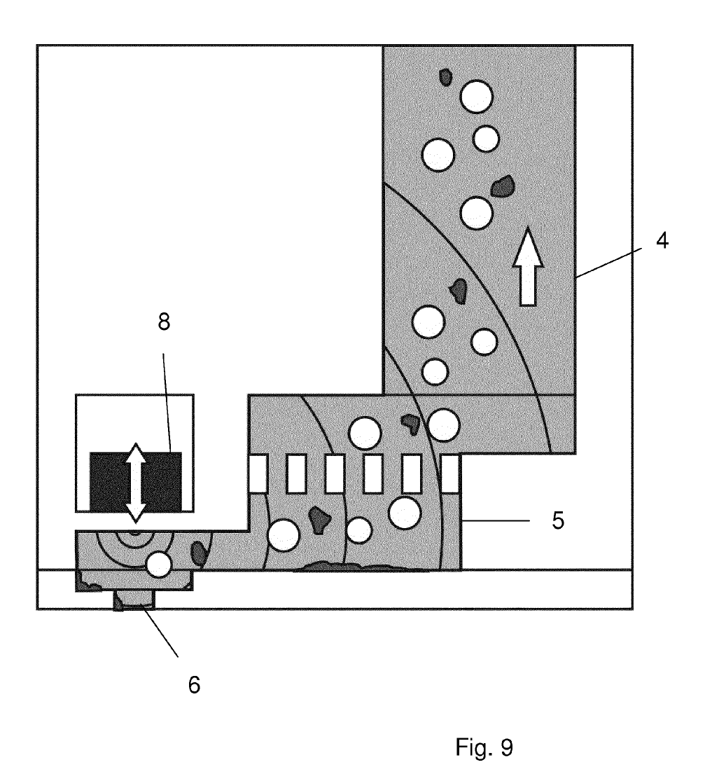

FIG. 9 shows a lateral sectional view like FIGS. 7 and 8, wherein the cleaning is supported by applying negative pressure upstream of the nozzle,

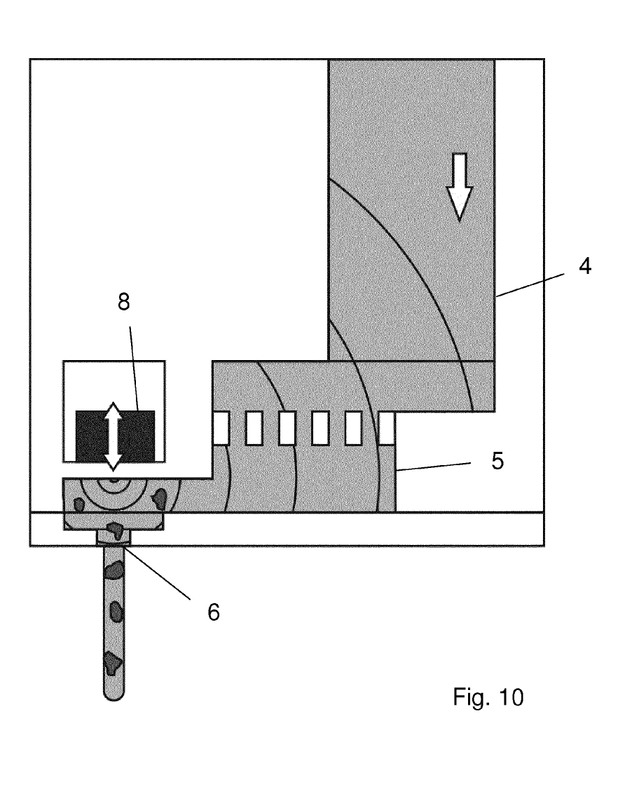

FIG. 10 shows a lateral sectional view like in FIGS. 7 to 9, wherein the cleaning is supported by applying positive pressure upstream of the nozzle and the deposits are thereby rinsed out of the printhead with the ink,

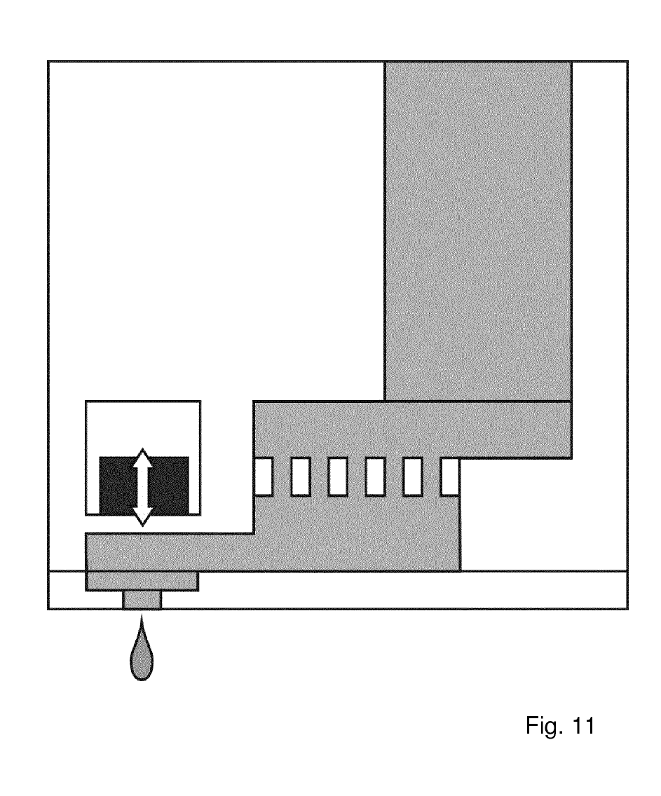

FIG. 11 shows a lateral sectional view like in FIGS. 7 to 10, wherein the nozzle functions normally again after cleaning has been carried out, and

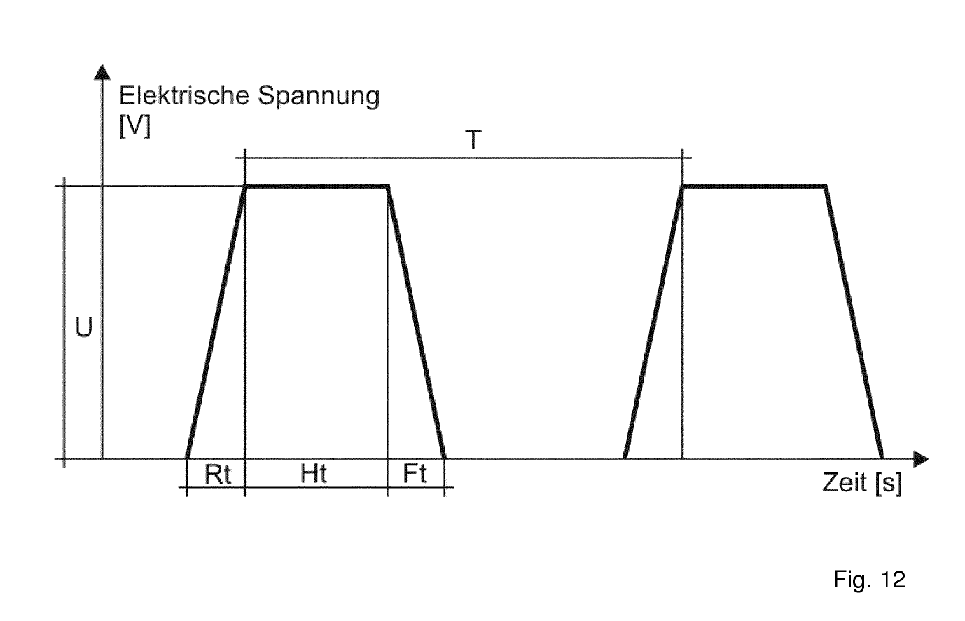

FIG. 12 shows the pulse shape of a control signal actuating the piezo elements during the cleaning process.

FIG. 1 schematically shows a piezo printhead from the front in a sectional view. The piezo printhead 2 has ink feed systems 4 which lead to a collecting line 5. A plurality of nozzles 6 (of which only one is provided with reference numbers) are connected to the collecting line 5. A piezo element 8, which can act mechanically on the nozzle 6 in order to discharge liquid from the nozzle 6, is allocated to each nozzle 6. Each piezo element 8 can be actuated individually by a control unit and is supplied with control pulses by the control unit in order to carry out the discharge of drops, individually controlled, for each nozzle 6.

FIG. 2 shows a schematic section through the piezo printhead with a detail magnification in the area of a nozzle 6. Through the control unit, each piezo element 8 is controlled by voltage pulses which bring about a controlled expansion/contraction of the piezo element 8. This change in expansion is transmitted mechanically onto the ink in the area upstream of the nozzle 6, in order to thus bring about the discharge of a drop of ink from the nozzle 6 by a targeted control pulse onto the piezo element 8.

A further sectional view of the piezo printhead is shown in FIG. 3. The piezo printhead here is provided with an ink chamber 10, from which ink can be fed into the ink feed systems 4. A negative pressure PM is generated in the ink chamber 10. This negative pressure is necessary in the nozzle to maintain the meniscus necessary for generating the drops, wherein the liquid column in the reservoir is to be taken into consideration. For this negative pressure, the following relationship applies:

P_{M}≈−(P_{capillary}+ρ·g·h),

wherein ρ is the density of the ink, g is the gravitational acceleration and h is the height of the liquid level in the ink chamber above the nozzle outlet. P_{capillary} is the negative pressure needed to generate the meniscus in the capillary (nozzle) and as a rule measures 2.5 to 10 mbar.

FIG. 4 shows a corresponding sectional view like FIG. 3, wherein the pressure in the ink chamber is now further reduced below the pressure P_{M}. Air is sucked in through the nozzles by applying a strong negative pressure. The ink is withdrawn from the nozzle and the generation of drops is prevented.

In FIG. 5, the situation is represented in which the ink chamber is provided with a positive pressure above P_{M}. If the positive pressure is high enough, the ink is pressed out of the nozzle as a jet of liquid.

The generation of positive or negative pressure in the ink chamber can take place for example using a controllable pump or another controllable air-pressure source which is connected to the ink chamber via a line and which is controlled by the control unit.

FIG. 6 shows a section of the piezo printhead in a lateral section, wherein here the piezo element 8 is stimulated by the control unit to generate ultrasound waves with a frequency of at least 20 kHz. The ultrasound waves spreading in the ink liquid and also in the direction of the nozzle 6 are represented schematically.

The section of the piezo printhead is shown again in a section in FIG. 7, wherein here it is indicated that deposits have formed in the base area of the collecting line and in the area of the nozzle. Because of these deposits, the nozzle 6 is partially blocked and its functioning is therefore disrupted.

It is provided that the nozzles of the piezo printhead are cleaned at regular intervals or are cleaned when it has been established that a nozzle is partially or completely blocked. The control device of the piezo printhead can monitor the functioning of the nozzles. This can take place for example by recording the pressure in the ink liquid upstream of the nozzle 6. Another possibility is that the control device records the pattern of the printed ink and tests for points where an incomplete printing result has been achieved due to deficient issue of liquid from a nozzle. If one or more nozzles are recorded as disrupted, the piezo printhead is moved out of the construction area of the shaped body about to be constructed and all of its nozzles or only the nozzles recorded as disrupted in their functioning are subjected to a nozzle cleaning.

The process of the nozzle cleaning is represented schematically in the sequence of lateral sectional representations in FIGS. 7 to 10. In FIG. 7 the situation has occurred that a nozzle is partially blocked by deposits. At the start of the nozzle cleaning, the control unit causes the piezo element 8 to vibrate using high-frequency control pulses, with the result that the piezo element emits ultrasound waves with frequencies of at least 20 kHz. The ultrasound waves propagate in the ink liquid, as represented in FIG. 8. Cavitation generated in the ink liquid has a mechanical effect on the material deposits, which are thereby comminuted and released.

The nozzle cleaning is supported by an alternating pressurization of the ink chamber with negative and positive pressure, with the result that a pulsating, oscillating flow through the nozzle is generated, by which the released deposits are to be washed away. This alternating supply to the ink of negative pressure and positive pressure is represented schematically in FIGS. 9 and 10, in which in FIG. 9 a negative pressure is applied, which sucks ink upwards out of the nozzle and air bubbles through the nozzle into the collecting line and the ink feed system. Through the subsequent supply to the ink of positive pressure in FIG. 10, ink is pressed outwards through the nozzle 6 in a jet of liquid, whereby released parts of the deposits are washed away. The pulsating supply to the ink of negative pressure and positive pressure as represented in FIGS. 9 and 10 can take place, alternating, for example with a frequency of from 0.1 to 1 Hz.

To carry out the cleaning function, the piezo elements can be operated with high-amplitude voltage pulses and with steep pulse edges (short rise and fall times) to increase the transmitted mechanical energy. The pulse shape can correspond to a trapezium shape (see FIG. 12), wherein Rt corresponds to the rise time, Ht to the holding time and Ft to the fall time of the pulse. Depending on the printhead, the rise and fall times can assume values in the range of from 1 to 4 μs, the holding times as a rule measure 0 to 15 μs. The amplitude U depends on the printhead present and the corresponding piezo elements and should be at least 80% of the maximum electrical voltage for the specific printhead. Depending on the printhead, values for this of from 20 to 200 V are applied. T corresponds to the period and is the reciprocal of the resultant frequency. At at least 20 kHz, the period is therefore at most 50 μs.

1. Process for the layered construction of a shaped body by means of a 3D inkjet printing process with a piezo printhead (2) which has an ink feed system (4) and several nozzles (6) connected thereto, to each of which a piezo element (8) is allocated which can act on the associated nozzle, in order to discharge ink from it, wherein each piezo element of the piezo printhead can be actuated individually by a control unit to discharge ink and its discharge is monitored by the control unit, wherein in the process the piezo printhead (2) is moved, controlled by the control unit, over a construction area, the piezo elements are actuated individually by the control unit for the locally selective application of filled ink, in order to thus apply a layer with a contour predetermined by the control unit, the applied layer is allowed to cure and the desired shaped body is constructed by successive application of layers, each with a predetermined contour, characterized in that the control unit is arranged to move the piezo printhead out of the construction area after a predetermined number of printed layers and/or if the control unit records a reduced discharge of ink in a nozzle (6) of the piezo printhead (2), then subject the nozzle or nozzles with reduced discharge or all the nozzles of the piezo printhead to a nozzle cleaning by stimulating the piezo element or elements (8) of the nozzles to be cleaned with a frequency of at least 20 kHz to generate ultrasound waves, in order to comminute and release any deposits in the nozzle.

2. Process according to claim 1, characterized in that during the nozzle cleaning, in addition to the application of ultrasound, alternating hydrostatic positive and negative pressure is generated via the nozzle or nozzles, in order to wash away released deposits out of the nozzle or nozzles of the piezo printhead (2).

3. Process according to claim 2, characterized in that, for the nozzle cleaning, the piezo elements (8) are actuated by periodic control pulses with short rise times (Rt) in the range of from 1 to 4 μs.

4. Process according to claim 3, characterized in that, for the nozzle cleaning, the piezo elements (8) are actuated by periodic control pulses with short fall times (Ft) in the range of from 1 to 4 μs.

5. Process according to claim 4, characterized in that the amplitude of the control pulses for the nozzle cleaning is at least 80% of the maximum allowable amplitude for the piezo elements (8).

6. Device for the layered construction of a shaped body with a 3D inkjet printing process with a piezo printhead (2) which has an ink feed system (4) and several nozzles (6) connected thereto, to each of which a piezo element (8) is allocated which can act on the associated nozzle (6), in order to discharge ink from it, a control unit by which the piezo elements (8) of the piezo printhead (2) can be actuated individually to discharge ink through the associated nozzle, and with devices for monitoring the functioning of the nozzles through the control unit, wherein the control unit is set up to move the piezo printhead over a construction area during the construction of a shaped body, control the piezo elements individually for the locally selective release of filled ink through the associated nozzles, in order to thus apply a layer with a contour predetermined by the control unit, and construct the desired shaped body by successive applications of layers, each with a predetermined contour, characterized in that the control device is further arranged to move the piezo printhead out of the construction area for the shaped body after a predetermined number of printed layers and/or if the control unit records a reduced discharge of ink in a nozzle (6) of the piezo printhead (2) and then subject the nozzle or nozzles with reduced discharge or all the nozzles of the piezo printhead to a nozzle cleaning by applying a frequency of at least 20 kHz to the piezo element or elements (8) of the nozzles (6) to be cleaned to generate ultrasound waves, in order to comminute and release any deposits in the nozzle.

7. Device according to claim 6, characterized in that there is a controllable pressure-generating device which acts on the ink in the ink feed system (4) and in the nozzles (6), and the control unit is set up, in connection with a nozzle cleaning, to apply negative and positive pressure, alternating, via the nozzles to be cleaned, with the result that deposits are washed away by a pulsating, oscillating ink flow through the nozzle or nozzles.
